(19) United States
(12) Patent Application Publication
(10) Pub. No.: US 2024/0169135 A1
(43) Pub. Date: May 23, 2024

(54) REINFORCEMENT LEARNING (RL) BASED CHIP DESIGN OPTIMIZATION USING TRAINED GRAPH CONVOLUTIONAL NETWORKS (GCN) FOR ULTRA-FAST COST FUNCTION CALCULATION

(71) Applicant: Synopsys, Inc., Sunnyvale, CA (US)

(72) Inventors: Joseph Robb WALSTON, Durham, NC (US); Stylianos DIAMANTIDIS, Sunnyvale, CA (US); Akash LEVY, Stanford, CA (US)

(21) Appl. No.: 18/216,510

(22) Filed: Jun. 29, 2023

Related U.S. Application Data
(60) Provisional application No. 63/426,855, filed on Nov. 21, 2022.

(51) Int. Cl. G06F 30/337; G06F 30/327

(52) U.S. Cl. CPC G06F 30/337; G06F 30/327

(57) ABSTRACT

Reinforcement learning (RL) based chip design optimization using trained graph convolutional networks (GCN) may include generating an elaborated circuit design based on a high-level circuit design and permuton values for permutons of the high-level circuit design, inferring metrics of the elaborated circuit design with a machine-learning (ML) engine, evaluating the inferred metrics and the permuton values of the elaborated circuit design and revising the permuton values based the evaluation to optimize the inferred metrics, using a RL engine, and revising the elaborated circuit design based on the revised permuton values. An apparatus may include a ML engine that infers metrics of an elaborated circuit design, and a RL engine that determines a correlation between the inferred metrics and permuton values of the elaborated circuit design and revises the permuton values based on the inferred metrics and the correlation to optimize the inferred metrics with respect to optimization criterion.

### RELATED APPLICATION

This application claims the benefit of U.S. Provisional Application for Patent No. 63/426,855, titled “Reinforcement Learning (RL) Based Chip Design Optimization Using Trained Graph Convolutional Networks (GCN) for Ultra-Fast Cost Function Calculation,” filed Nov. 21, 2022, which is incorporated herein by reference in its entirety.

### TECHNICAL FIELD

The present disclosure relates to integrated circuit electronic design automation (EDA) and, more particularly, to reinforcement learning (RL) based chip design optimization using trained graph convolutional networks (GCN) for ultra-fast cost function calculation.

### BACKGROUND

Integrated circuit (IC) design is highly complex and typically involves a variety of electronic design automation (EDA) tools. IC design typically involves numerous highly-tunable steps (e.g., synthesis, floorplanning, placement, clock tree synthesis, routing, etc.), with numerous technology/design dependencies. As IC designs increase in complexity, performing full physical design runs to evaluate a design or a proposed design change can become prohibitively expensive, in terms of time, computing resources, and license fees. The increasing complexity motivates the need for simpler/faster solutions to evaluate quality-of-results (QoR).

### SUMMARY

The present disclosure relates to reinforcement learning (RL) based chip design optimization using trained graph convolutional networks (GCN) for ultra-fast cost function calculation.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a block diagram of a circuit design optimization system that includes a circuit optimization engine that includes a machine-learning (ML) engine (e.g., a graph convolutional network) and a reinforcement learning (RL) engine, according to an embodiment.

FIG. 2 is a flowchart of a method of optimizing a circuit design, according to an embodiment.

FIG. 3 illustrates example permuton (i.e., variable circuit parameter) abstraction levels, according to an embodiment.

FIG. 4 illustrates example layers of a graph convolutional network, according to an embodiment.

FIG. 5 is a block diagram of the circuit design optimization system in which the machine-learning engine is trained with training data from a training data source, according to an embodiment.

FIG. 6 illustrates an example set of processes used during the design, verification, and fabrication of an article of manufacture such as an integrated circuit to transform and verify design data and instructions that represent the integrated circuit, according to an embodiment.

FIG. 7 depicts a diagram of an example emulation environment, according to an embodiment.

FIG. 8 illustrates an example machine of a computer system within which a set of instructions, for causing the machine to perform any one or more of the methodologies discussed herein, may be executed, according to an embodiment.

### DETAILED DESCRIPTION

Aspects of the present disclosure relate to reinforcement learning (RL) based chip design optimization using trained graph convolutional networks (GCN) for ultra-fast cost function calculation.

The integrated circuit (IC) design/fabrication industry is entering an era where an IC die may contain tens of billions of transistors, and a full physical design cycle for even a single block of circuitry may take hours or even days. A big challenge that designers face today is rapidly evaluating how a design change will affect quality of results (QoR). Conventional electronic design automation (EDA) tools estimate certain metrics (e.g., power, performance, and area, or PPA) by emulating the physical design process at a coarse level of granularity (i.e., by developing rough floorplans and placement/routing estimates). However, calibrating these models to real signoff results can prove challenging, and the performance benefits may not be large enough (usually less than an order of magnitude) to enable deep design space exploration.

Embodiments disclosed herein include a hardware design optimization architecture that includes a graph convolutional network (GCN) for predicting end-to-end quality of result (QoR) metrics based on register transfer level (RTL) design parameters, and a reinforcement learning (RL) based optimization system to make design decisions based on predicted metrics. A graph convolutional network (GCN) is an approach for semi-supervised learning on graph-structured data. GCN is based on a variant of convolutional neural networks, which operate directly on graphs. RL is an area of machine learning that deals with how intelligent agents should take actions in an environment in order to maximize a cumulative reward. RL differs from supervised learning in that RL does not need labelled input/output pairs, or explicit correction of sub-optimal actions. Rather, RL seeks a balance between exploration (of uncharted territory) and exploitation (of current knowledge). The GCN and RL components work together to create a hardware design optimization framework that automates design decisions based on accurate predictions within suitable timeframes for a design workflow. A GCN and the RL based optimization system, as disclosed herein, may be useful to provide a unified framework and workflow.

Techniques disclosed may be useful to make speculations based on design code (e.g., elaborated netlists and RTL design parameters), referred to as technology-independent RTL elaboration. Speculative analysis is a dynamic technique that helps developers make better decisions by informing them of the consequences of their likely actions. A speculative analysis tool generates a set of likely actions a developer might perform, makes a copy of the project code, and applies each of those actions to the copy in the background. After each application, the tool analyzes the resulting code and reports its findings to the developer.

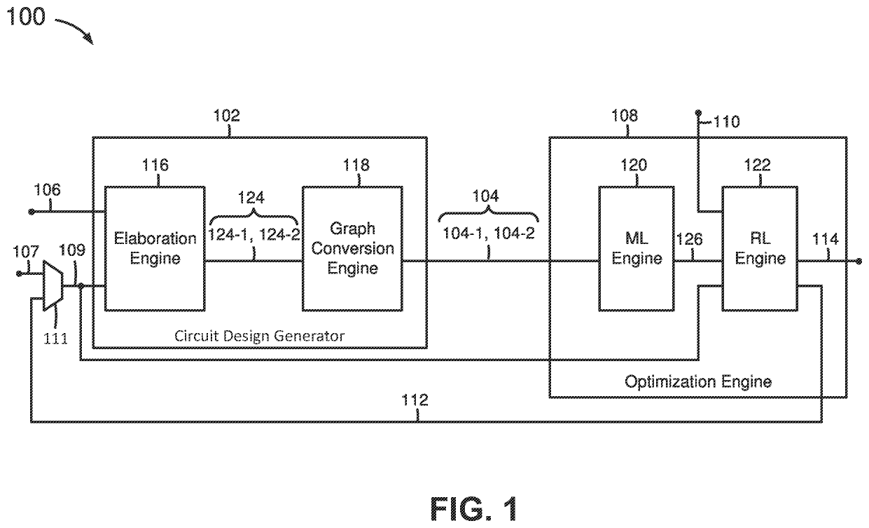

FIG. 1 is a block diagram of a circuit design optimization system 100, according to an embodiment. System 100 includes a circuit design generator 102 that generates elaborated circuit designs 104 based on a high-level circuit design 106 and values 109 for permutons (i.e., tunable/selectable parameters or knobs of high-level circuit design 106, such as knobs that control register transfer level (RTL) generation and clock period constraints).

System 100 further includes an artificial intelligence machine-learning (AIML) circuit optimization engine (circuit optimization engine) 108 that evaluates elaborated circuit designs 104 based on optimization criteria 110, provides feedback 112 (e.g., permuton values) to circuit design generator 102 to permit circuit design generator 102 to generate additional elaborated circuit designs 104. Circuit optimization engine 108 then selects one or more of the elaborated circuit designs 104 as an optimum circuit design(s) 114.

In the example of FIG. 1, circuit design generator 102 includes an elaboration engine 116 and a graph conversion engine 118, and circuit optimization engine 108 includes a machine-learning (ML) engine 120 and a reinforcement learning (RL) engine, which are described further below.

System 100 may be useful for testing/evaluating a design space (e.g., an RTL design space) of a circuit design, where the design space is defined by permutons associated with the circuit design. System 100 may be useful as a fast proxy metric generator and can be viewed as an AI-based value function reinforcement learning based optimizing of RTL parameters of a circuit design. System 100 may be useful as a speculation engine that explores a design space (e.g., an RTL design space). System 100 may be useful for obtaining decisions on design content choices prepared by a designer within acceptable workflow processing timeframes (e.g., within minutes to hours). System 100 may be useful as a framework to search across numerous (e.g., thousands) of design configurations and find configurations that are optimal based on predicted metrics of the design configurations, within typical workflow timeframes for a hardware design engineer (minutes to hours).

System 100 may include circuitry that performs various functions disclosed herein. The circuitry may be combined or distributed in one or more of a variety of combinations, without deviating from the scope of the present disclosure. Alternatively, or additionally, system 100 may include a processor and memory configured with instructions/code to perform one or more of the functions disclosed herein. System 100 may be implemented as part of an electronic design automation (EDA) system. System 100 may be implemented on a single platform or may be distributed across multiple platforms.

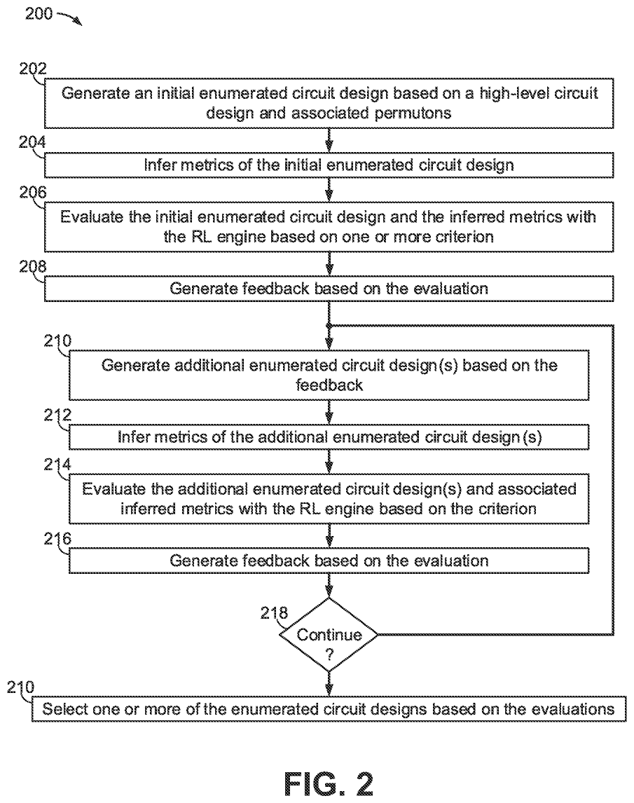

System 100 is described below with reference to FIG. 2. FIG. 2 is a flowchart of a method 200 of optimizing a circuit design, according to an embodiment. Method 200 may be performed as a part of a simulation phase of an IC design workflow. Method 200 is described below with reference to system 100. Method 200 is not, however, limited to the example of system 100.

Method 200 begins with high-level circuit design 106 and initial permuton values 107. High-level circuit design 106 may include a netlist, and may be represented in a hardware description language (HDL). Example HDLs include, without limitation, VHDL, Verilog, SystemVerilog, SystemC, MyHDL or OpenVera.

The physical design process of an integrated circuit is complex, typically involving numerous highly-tunable steps (e.g., synthesis, floorplanning, placement, clock tree synthesis, routing, etc.), and a large number of technology/design dependencies, collectively referred to herein as permutons. In an embodiment, permutons are encoded in high-level circuit design 106 as parameters (e.g., as RTL design parameters).

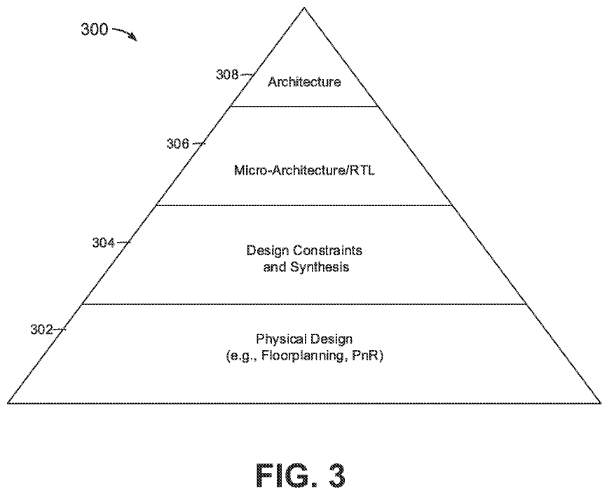

High-level circuit design 106 may include permutons at one or more levels of abstraction. FIG. 3 illustrates example permuton abstraction levels 300, according to an embodiment. Abstraction levels 300 include an implementation, or physical design level 302 (e.g., floorplanning, place and route, frequency target, and a desired degree of design hierarchy flattening), a design constraints and synthesis level 304, a micro-architecture/register transfer level (RTL) level 306 (e.g., adder/multiplier architecture, clock gating strategies, and error correcting code (ECC) schemes), and an architecture level 308 (e.g., instruction set and memory/cache hierarchy).

There is a notable lack of solutions that target micro-architectural/RTL implementation level 306. In an embodiment, high-level circuit design 106 include micro-architecture/RTL level permutons and may further include architectural/physical design permutons. High-level circuit design 106 is not, however, limited to micro-architecture/RTL level permutons or architectural/physical design permutons.

At 202 of method 200, circuit design generator 102 generates an initial elaborated circuit design 104-1 based on high-level circuit design 106 and initial permuton values 107. In an embodiment, circuit design generator 102 generates multiple initial elaborated circuit designs 104-1 based on respective sets of permuton values 107, and the remainder of method 200 is performed with respect to the multiple initial elaborated circuit designs (e.g., in parallel). Alternatively, circuit design generator 102 generates elaborated circuit designs 104 in a serial fashion. Circuit design generator 102 may perform technology-independent RTL elaboration.

In order to keep a design space tractable, permutons of high-level circuit design 106 may be constrained to take on a finite number of discrete values. For categorical permutons, such a constraint does not pose a challenge. Permutons that extend over a continuous space may be discretized (linearly or logarithmically) between finite bounds. In an embodiment, a target clock period (clk_period) may be varied as a permuton (e.g., between 2 nanoseconds (ns) and 10 ns) to evaluate an IC design with low/high performance targets.

In the example of FIG. 1, elaboration engine 116 generates an initial elaborated circuit design 124-1, based on initial permuton values 107. Initial elaborated circuit design 124-1 may include logic-level register transfer level (RTL) descriptions of high-level circuit design 106 (e.g., an elaborated netlist). Initial elaborated circuit design 124-1 may include logic level design data, such as procedural logic, including signed/unsigned arithmetic with varying bit widths, comparison, multiplexing, left/right shifting, type-casting, and padding.

Further in the example of FIG. 1, graph conversion engine 118 converts initial elaborated circuit design 124-1 to a graph-based initial elaborated circuit design 104-1. A graph-based initial elaborated circuit design 104-1 may include nodes that represent logical operations of initial elaborated circuit design 124, and edges that represent connections or flow amongst the logical operations. The nodes may be represented as node-level vectors, and permutons may be represented as a graph-level vector.

Graph conversion engine 118 may output initial elaborated circuit design 104-1 in a format that is suitable for circuit optimization engine 108 (e.g., as a Deep Graph Library, or DGL). Alternatively, a designer may construct an initial elaborated graph, and graph conversion engine 118 may convert the initial elaborated graph into a suitable format for circuit optimization engine 108.

At 204, ML engine 120 infers metrics 126 of initial elaborated circuit design 104-1. Metrics 126 may include, without limitation, quality-of-results (QoR), such as, without limitation, power, performance, and area (PPA) metrics. Alternatively, or additionally, metrics 126 may include, without limitation, a cell area metric, a netlist area metric, a total power metric, an internal power metric, a total dynamic power metric, a leakage power metric, a switching power metric, a congestion metric, a global routing congestion metric, a total negative slack metric, a worst negative slack (WNS) metric, a total negative slack (TNS) metric, and/or executions per clock cycle.

ML engine 120 may include a graph neural network (GNN), or a variant thereof, such as a graph convolutional network (GCN). GNNs operate by constructing node-level features via matrix multiplication, then pooling/aggregating the node-level features to solve a desired task. Graph convolutional networks (GCNs) are a variant in which node-level features are locally aggregated from neighboring nodes using a process that is analogous to convolution. As disclosed herein, a GCN may be applied to elaborated netlists to serve as end-to-end physical design metric predictors.

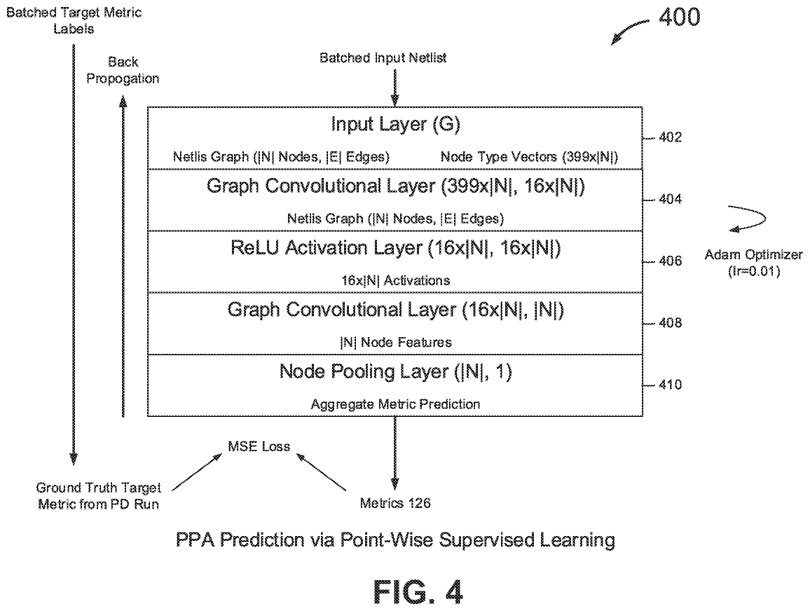

FIG. 4 illustrates example layers of a GCN 400, according to an embodiment. In the example of FIG. 4, GCN 400 includes an input layer 402, a first graph convolutional layer 404, an activation layer 406, a second graph convolutional layer 408, and a node pooling/aggregation layer 410 (i.e., depending upon the metric(s) for which GCN 400 is trained to infer).

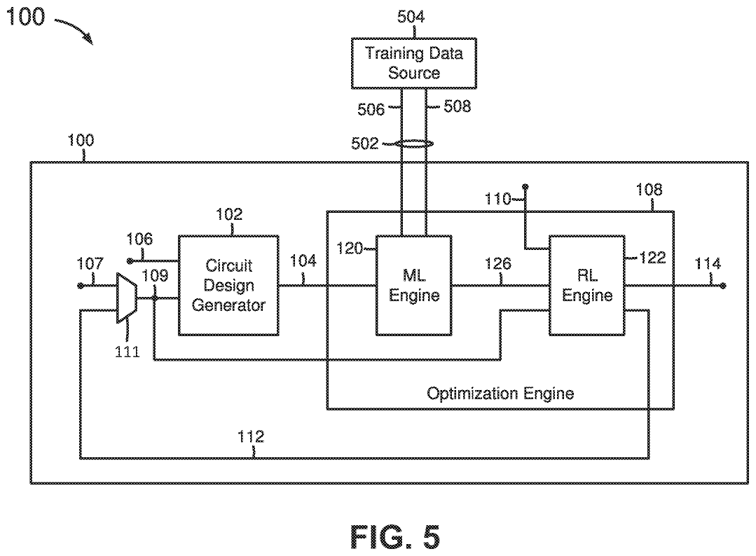

ML engine 120 may be trained to predict, or infer metrics 126 based on training data, such as described further below with reference to FIG. 5.

At 206, RL engine 122 evaluates initial elaborated circuit design 104-1 and corresponding inferred metrics 126 based optimization criteria 110.

RL engine 122 may perform a search and optimization procedure. RL engine 122 may, for example, search permutations of the permutons (an entire parameter set) for optimal sets of permuton values, as measured by quantifiable success criteria, such as test bench-based performance characteristics and/or GCN-predicted implementation results. RL engine 122 may search dependent parameters (e.g., tens or hundreds of dependent parameters) with complex (e.g., non-linear, discontinuous) responses. RL engine 122 may employ one or more of a variety of RL methods, which may be based on an application of system 100. Factors to consider in selecting a RL method may include the proportion of compute resources dedicated to exploration, and identification and refinement of numerous local sub-spaces for exploitation (i.e., localized optimization). Example RL methods include, without limitation, Bayesian, gradient boost, and particle swarm.

At 208, RL engine 122 generates feedback 112 based on the evaluation of initial elaborated circuit design 104-1. In an embodiment, RL engine 122 determines correlations between permuton values 107 of initial elaborated circuit design 104-1 and corresponding metrics 126, determines permuton values to be applied in a subsequent cycle based on the correlations, and provides the permuton values in feedback 112. RL engine 122 may generate feedback 112 (i.e., permuton values) to optimize metrics 126 relative to optimization criteria 110 (i.e., reward optimization, or exploitation). RL engine 122 may perform a combination of exploration (i.e., random variations/selections of permuton values) and exploitation (e.g., optimizing permuton values based on prior iterations).

In the example of FIG. 1, system 100 further includes a multiplexer 111 that is controllable to provide initial permuton values 107 or feedback 112 to circuit design generator 102.

At 210, circuit design generator 102 generates one or more additional elaborated circuit designs 104-2 based on feedback 112. Elaborated circuit design(s) 104-2 may represent a variation of initial elaborated circuit design 104-1.

At 212, ML engine 120 infers metrics 126 of elaborated circuit design(s) 104-2, such as described above with reference to 204.

At 214, RL engine 122 evaluates elaborated circuit design(s) 104-2 and corresponding inferred metrics 126, such as described above with reference to 206.

At 216, RL engine 122 generates feedback 112 based on the evaluation of elaborated circuit design(s) 104-2, such as described above with reference to 208.

At 218, processing may return to 210 to generate and evaluate one or more additional elaborated circuit designs 104-2 (e.g., variations of initial elaborated circuit design 104-1 and/or variations of a preceding elaborated circuit design 104-2).

At 220, RL engine 122 selects one or more of elaborated circuit designs 104 as optimum circuit design 114 based on inferred metrics 126 of the respective elaborated circuit designs 104 and optimization criteria 110. RL engine 122 may select an elaborated circuit design 104 for which the inferred metrics 126 are closest to optimization criteria 110.

Where RL engine 122 selects multiple elaborated circuit designs 104, circuit optimization engine 108 may provide the selections in a statistical likelihood framework, which may be useful to provide a downstream engineering team a degree of configurability in the circuit design, with confidence that they have a set of optimal configurations.

FIG. 5 is a block diagram of system 100 in which ML engine 120 is trained with training data 502 from a training data source 504, according to an embodiment. Training data 502 includes training elaborated circuit designs 506 and training metrics 508 of the respective training elaborated circuit designs 506. Training elaborated circuit designs 506 may be represented as described above with respect to elaborated circuit designs 104.

In an embodiment, circuit design generator 102 generates training elaborated circuit designs 506, or a portion thereof, based on high-level circuit design 106 and the associated permutons, such as described further above. In this example, training metrics 508 may be computed (e.g., by a synthesis engine). Alternatively, or additionally, training elaborated circuit designs 506, or a portion thereof, may represent circuit designs that are not generated from high-level circuit design 106. In this example, training metrics 508 may be computed (e.g., by a synthesis engine) and/or measured from physical design runs (i.e., measured from physical implementations of the respective training elaborated circuit designs 506).

ML engine 120 may be trained with a supervised or semi-supervised learning technique (i.e., using training metrics 508 as labels for respective training elaborated circuit designs 506). ML engine 120 may be trained to predict or infer metrics 126 at one or more of multiple levels of abstraction, such as described above with reference to FIG. 3.

Trained ML engine 120 may be useful to permit a hardware designer to infer or predict metrics 126 for a proposed design or design change relatively quickly without waiting or involving other engineering teams.

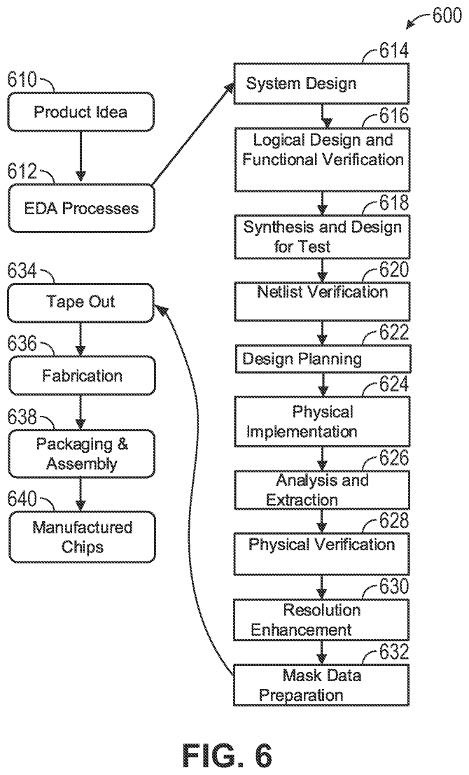

FIG. 6 illustrates an example set of processes 600 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 610 with information supplied by a designer, information which is transformed to create an article of manufacture that uses a set of EDA processes 612. When the design is finalized, the design is taped-out 634, which is when artwork (e.g., geometric patterns) for the integrated circuit is sent to a fabrication facility to manufacture the mask set, which is then used to manufacture the integrated circuit. After tape-out, a semiconductor die is fabricated 636 and packaging and assembly processes 638 are performed to produce the finished integrated circuit 640.

Specifications for a circuit or electronic structure may range from low-level transistor material layouts to high-level description languages. A high-level of representation may be used to design circuits and systems, using a hardware description language (‘HDL’) such as VHDL, Verilog, SystemVerilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 6. The processes described by be enabled by EDA products (or EDA systems).

During system design 614, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 616, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 618, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 620, the netlist is checked for compliance with timing constraints and for correspondence with the HDL code. During design planning 622, an overall floor plan for the integrated circuit is constructed and analyzed for timing and top-level routing.

During layout or physical implementation 624, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 626, the circuit function is verified at the layout level, which permits refinement of the layout design. During physical verification 628, the layout design is checked to ensure that manufacturing constraints are correct, such as DRC constraints, electrical constraints, lithographic constraints, and that circuitry function matches the HDL design specification. During resolution enhancement 630, the geometry of the layout is transformed to improve how the circuit design is manufactured.

During tape-out, data is created to be used (after lithographic enhancements are applied if appropriate) for production of lithography masks. During mask data preparation 632, the ‘tape-out’ data is used to produce lithography masks that are used to produce finished integrated circuits.

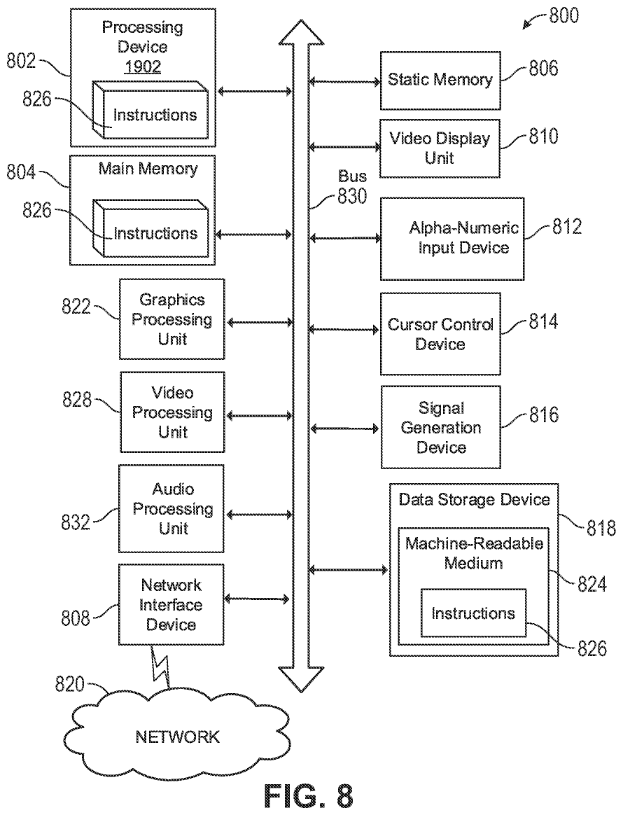

A storage subsystem of a computer system (such as computer system 800 of FIG. 8, or host system 1807 of FIG. 18) may be used to store the programs and data structures that are used by some or all of the EDA products described herein, and products used for development of cells for the library and for physical and logical design that use the library.

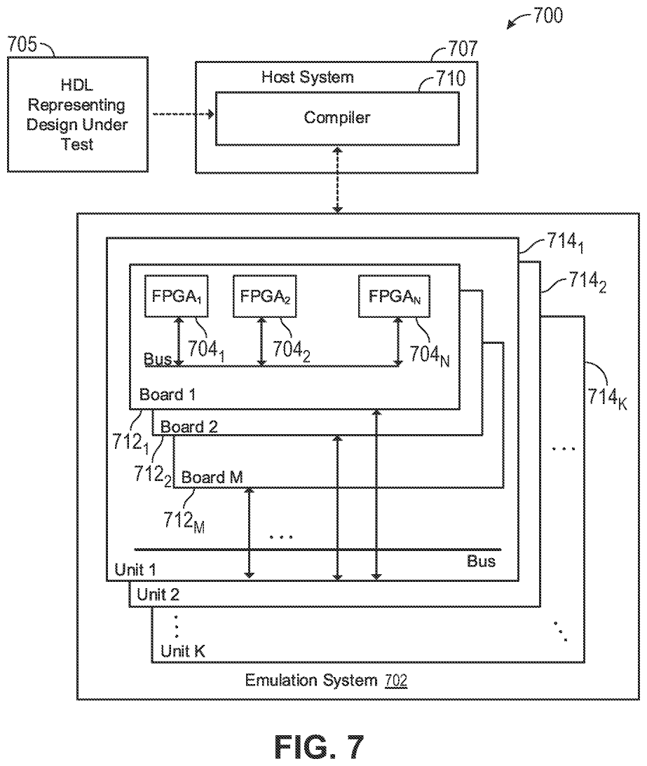

FIG. 7 depicts a diagram of an example emulation environment 700. An emulation environment 700 may be configured to verify the functionality of the circuit design. The emulation environment 700 may include a host system 707 (e.g., a computer that is part of an EDA system) and an emulation system 702 (e.g., a set of programmable devices such as Field Programmable Gate Arrays (FPGAs) or processors). The host system generates data and information by using a compiler 710 to structure the emulation system to emulate a circuit design. A circuit design to be emulated is also referred to as a Design Under Test (‘DUT’) where data and information from the emulation are used to verify the functionality of the DUT.

The host system 707 may include one or more processors. In the embodiment where the host system includes multiple processors, the functions described herein as being performed by the host system can be distributed among the multiple processors. The host system 707 may include a compiler 710 to transform specifications written in a description language that represents a DUT and to produce data (e.g., binary data) and information that is used to structure the emulation system 702 to emulate the DUT. The compiler 710 can transform, change, restructure, add new functions to, and/or control the timing of the DUT.

The host system 707 and emulation system 702 exchange data and information using signals carried by an emulation connection. The connection can be, but is not limited to, one or more electrical cables such as cables with pin structures compatible with the Recommended Standard 232 (RS232) or universal serial bus (USB) protocols. The connection can be a wired communication medium or network such as a local area network or a wide area network such as the Internet. The connection can be a wireless communication medium or a network with one or more points of access using a wireless protocol such as BLUETOOTH or IEEE 702.11. The host system 707 and emulation system 702 can exchange data and information through a third device such as a network server.

The emulation system 702 includes multiple FPGAs (or other modules) such as FPGAs 704₁ and 704₂ as well as additional FPGAs to 704_{N}. Each FPGA can include one or more FPGA interfaces through which the FPGA is connected to other FPGAs (and potentially other emulation components) for the FPGAs to exchange signals. An FPGA interface can be referred to as an input/output pin or an FPGA pad. While an emulator may include FPGAs, embodiments of emulators can include other types of logic blocks instead of, or along with, the FPGAs for emulating DUTs. For example, the emulation system 702 can include custom FPGAs, specialized ASICs for emulation or prototyping, memories, and input/output devices.

A programmable device can include an array of programmable logic blocks and a hierarchy of interconnections that can enable the programmable logic blocks to be interconnected according to the descriptions in the HDL code. Each of the programmable logic blocks can enable complex combinational functions or enable logic gates such as AND, and XOR logic blocks. In some embodiments, the logic blocks also can include memory elements/devices, which can be simple latches, flip-flops, or other blocks of memory. Depending on the length of the interconnections between different logic blocks, signals can arrive at input terminals of the logic blocks at different times and thus may be temporarily stored in the memory elements/devices.

FPGAs 704₁-804_{N} may be placed onto one or more boards 712₁ and 712₂ as well as additional boards through 712_{M}. Multiple boards can be placed into an emulation unit 714₁. The boards within an emulation unit can be connected using the backplane of the emulation unit or any other types of connections. In addition, multiple emulation units (e.g., 714₁ and 714₂ through 714_{K}) can be connected to each other by cables or any other means to form a multi-emulation unit system.

For a DUT that is to be emulated, the host system 707 transmits one or more bit files to the emulation system 702. The bit files may specify a description of the DUT and may further specify partitions of the DUT created by the host system 707 with trace and injection logic, mappings of the partitions to the FPGAs of the emulator, and design constraints. Using the bit files, the emulator structures the FPGAs to perform the functions of the DUT. In some embodiments, one or more FPGAs of the emulators may have the trace and injection logic built into the silicon of the FPGA. In such an embodiment, the FPGAs may not be structured by the host system to emulate trace and injection logic.

The host system 707 receives a description of a DUT that is to be emulated. In some embodiments, the DUT description is in a description language (e.g., a register transfer language (RTL)). In some embodiments, the DUT description is in netlist level files or a mix of netlist level files and HDL files. If part of the DUT description or the entire DUT description is in an HDL, then the host system can synthesize the DUT description to create a gate level netlist using the DUT description. A host system can use the netlist of the DUT to partition the DUT into multiple partitions where one or more of the partitions include trace and injection logic. The trace and injection logic traces interface signals that are exchanged via the interfaces of an FPGA. Additionally, the trace and injection logic can inject traced interface signals into the logic of the FPGA. The host system maps each partition to an FPGA of the emulator. In some embodiments, the trace and injection logic is included in select partitions for a group of FPGAs. The trace and injection logic can be built into one or more of the FPGAs of an emulator. The host system can synthesize multiplexers to be mapped into the FPGAs. The multiplexers can be used by the trace and injection logic to inject interface signals into the DUT logic.

The host system creates bit files describing each partition of the DUT and the mapping of the partitions to the FPGAs. For partitions in which trace and injection logic are included, the bit files also describe the logic that is included. The bit files can include place and route information and design constraints. The host system stores the bit files and information describing which FPGAs are to emulate each component of the DUT (e.g., to which FPGAs each component is mapped).

Upon request, the host system transmits the bit files to the emulator. The host system signals the emulator to start the emulation of the DUT. During emulation of the DUT or at the end of the emulation, the host system receives emulation results from the emulator through the emulation connection. Emulation results are data and information generated by the emulator during the emulation of the DUT which include interface signals and states of interface signals that have been traced by the trace and injection logic of each FPGA. The host system can store the emulation results and/or transmits the emulation results to another processing system.

After emulation of the DUT, a circuit designer can request to debug a component of the DUT. If such a request is made, the circuit designer can specify a time period of the emulation to debug. The host system identifies which FPGAs are emulating the component using the stored information. The host system retrieves stored interface signals associated with the time period and traced by the trace and injection logic of each identified FPGA. The host system signals the emulator to re-emulate the identified FPGAs. The host system transmits the retrieved interface signals to the emulator to re-emulate the component for the specified time period. The trace and injection logic of each identified FPGA injects its respective interface signals received from the host system into the logic of the DUT mapped to the FPGA. In case of multiple re-emulations of an FPGA, merging the results produces a full debug view.

The host system receives, from the emulation system, signals traced by logic of the identified FPGAs during the re-emulation of the component. The host system stores the signals received from the emulator. The signals traced during the re-emulation can have a higher sampling rate than the sampling rate during the initial emulation. For example, in the initial emulation a traced signal can include a saved state of the component every X milliseconds. However, in the re-emulation the traced signal can include a saved state every Y milliseconds where Y is less than X. If the circuit designer requests to view a waveform of a signal traced during the re-emulation, the host system can retrieve the stored signal and display a plot of the signal. For example, the host system can generate a waveform of the signal. Afterwards, the circuit designer can request to re-emulate the same component for a different time period or to re-emulate another component.

A host system 707 and/or the compiler 710 may include sub-systems such as, but not limited to, a design synthesizer sub-system, a mapping sub-system, a run time sub-system, a results sub-system, a debug sub-system, a waveform sub-system, and a storage sub-system. The sub-systems can be structured and enabled as individual or multiple modules or two or more may be structured as a module. Together these sub-systems structure the emulator and monitor the emulation results.

The design synthesizer sub-system transforms the HDL that is representing a DUT 705 into gate level logic. For a DUT that is to be emulated, the design synthesizer sub-system receives a description of the DUT. If the description of the DUT is fully or partially in HDL (e.g., RTL or other level of representation), the design synthesizer sub-system synthesizes the HDL of the DUT to create a gate-level netlist with a description of the DUT in terms of gate level logic.

The mapping sub-system partitions DUTs and maps the partitions into emulator FPGAs. The mapping sub-system partitions a DUT at the gate level into a number of partitions using the netlist of the DUT. For each partition, the mapping sub-system retrieves a gate level description of the trace and injection logic and adds the logic to the partition. As described above, the trace and injection logic included in a partition is used to trace signals exchanged via the interfaces of an FPGA to which the partition is mapped (trace interface signals). The trace and injection logic can be added to the DUT prior to the partitioning. For example, the trace and injection logic can be added by the design synthesizer sub-system prior to or after the synthesizing the HDL of the DUT.

In addition to including the trace and injection logic, the mapping sub-system can include additional tracing logic in a partition to trace the states of certain DUT components that are not traced by the trace and injection. The mapping sub-system can include the additional tracing logic in the DUT prior to the partitioning or in partitions after the partitioning. The design synthesizer sub-system can include the additional tracing logic in an HDL description of the DUT prior to synthesizing the HDL description.

The mapping sub-system maps each partition of the DUT to an FPGA of the emulator. For partitioning and mapping, the mapping sub-system uses design rules, design constraints (e.g., timing or logic constraints), and information about the emulator. For components of the DUT, the mapping sub-system stores information in the storage sub-system describing which FPGAs are to emulate each component.

Using the partitioning and the mapping, the mapping sub-system generates one or more bit files that describe the created partitions and the mapping of logic to each FPGA of the emulator. The bit files can include additional information such as constraints of the DUT and routing information of connections between FPGAs and connections within each FPGA. The mapping sub-system can generate a bit file for each partition of the DUT and can store the bit file in the storage sub-system. Upon request from a circuit designer, the mapping sub-system transmits the bit files to the emulator, and the emulator can use the bit files to structure the FPGAs to emulate the DUT.

If the emulator includes specialized ASICs that include the trace and injection logic, the mapping sub-system can generate a specific structure that connects the specialized ASICs to the DUT. In some embodiments, the mapping sub-system can save the information of the traced/injected signal and where the information is stored on the specialized ASIC.

The run time sub-system controls emulations performed by the emulator. The run time sub-system can cause the emulator to start or stop executing an emulation. Additionally, the run time sub-system can provide input signals and data to the emulator. The input signals can be provided directly to the emulator through the connection or indirectly through other input signal devices. For example, the host system can control an input signal device to provide the input signals to the emulator. The input signal device can be, for example, a test board (directly or through cables), signal generator, another emulator, or another host system.

The results sub-system processes emulation results generated by the emulator. During emulation and/or after completing the emulation, the results sub-system receives emulation results from the emulator generated during the emulation. The emulation results include signals traced during the emulation. Specifically, the emulation results include interface signals traced by the trace and injection logic emulated by each FPGA and can include signals traced by additional logic included in the DUT. Each traced signal can span multiple cycles of the emulation. A traced signal includes multiple states and each state is associated with a time of the emulation. The results sub-system stores the traced signals in the storage sub-system. For each stored signal, the results sub-system can store information indicating which FPGA generated the traced signal.

The debug sub-system allows circuit designers to debug DUT components. After the emulator has emulated a DUT and the results sub-system has received the interface signals traced by the trace and injection logic during the emulation, a circuit designer can request to debug a component of the DUT by re-emulating the component for a specific time period. In a request to debug a component, the circuit designer identifies the component and indicates a time period of the emulation to debug. The circuit designer's request can include a sampling rate that indicates how often states of debugged components should be saved by logic that traces signals.

The debug sub-system identifies one or more FPGAs of the emulator that are emulating the component using the information stored by the mapping sub-system in the storage sub-system. For each identified FPGA, the debug sub-system retrieves, from the storage sub-system, interface signals traced by the trace and injection logic of the FPGA during the time period indicated by the circuit designer. For example, the debug sub-system retrieves states traced by the trace and injection logic that are associated with the time period.

The debug sub-system transmits the retrieved interface signals to the emulator. The debug sub-system instructs the debug sub-system to use the identified FPGAs and for the trace and injection logic of each identified FPGA to inject its respective traced signals into logic of the FPGA to re-emulate the component for the requested time period. The debug sub-system can further transmit the sampling rate provided by the circuit designer to the emulator so that the tracing logic traces states at the proper intervals.

To debug the component, the emulator can use the FPGAs to which the component has been mapped. Additionally, the re-emulation of the component can be performed at any point specified by the circuit designer.

For an identified FPGA, the debug sub-system can transmit instructions to the emulator to load multiple emulator FPGAs with the same configuration of the identified FPGA. The debug sub-system additionally signals the emulator to use the multiple FPGAs in parallel. Each FPGA from the multiple FPGAs is used with a different time window of the interface signals to generate a larger time window in a shorter amount of time. For example, the identified FPGA can require an hour or more to use a certain amount of cycles. However, if multiple FPGAs have the same data and structure of the identified FPGA and each of these FPGAs runs a subset of the cycles, the emulator can require a few minutes for the FPGAs to collectively use all the cycles.

A circuit designer can identify a hierarchy or a list of DUT signals to re-emulate. To enable this, the debug sub-system determines the FPGA needed to emulate the hierarchy or list of signals, retrieves the necessary interface signals, and transmits the retrieved interface signals to the emulator for re-emulation. Thus, a circuit designer can identify any element (e.g., component, device, or signal) of the DUT to debug/re-emulate.

The waveform sub-system generates waveforms using the traced signals. If a circuit designer requests to view a waveform of a signal traced during an emulation run, the host system retrieves the signal from the storage sub-system. The waveform sub-system displays a plot of the signal. For one or more signals, when the signals are received from the emulator, the waveform sub-system can automatically generate the plots of the signals.

FIG. 8 illustrates an example machine of a computer system 800 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM), a static memory 806 (e.g., flash memory, static random access memory (SRAM), etc.), and a data storage device 818, which communicate with each other via a bus 830.

Processing device 802 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. The processing device 802 may be configured to execute instructions 826 for performing the operations and steps described herein.

The computer system 800 may further include a network interface device 808 to communicate over the network 820. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), a graphics processing unit 822, a signal generation device 816 (e.g., a speaker), graphics processing unit 822, video processing unit 828, and audio processing unit 832.

The data storage device 818 may include a machine-readable storage medium 824 (also known as a non-transitory computer-readable medium) on which is stored one or more sets of instructions 826 or software embodying any one or more of the methodologies or functions described herein. The instructions 826 may also reside, completely or at least partially, within the main memory 804 and/or within the processing device 802 during execution thereof by the computer system 800, the main memory 804 and the processing device 802 also constituting machine-readable storage media.

In some implementations, the instructions 826 include instructions to implement functionality corresponding to the present disclosure. While the machine-readable storage medium 824 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 802 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. An apparatus, comprising:
a circuit optimization engine comprising,
a machine-learning (ML) engine configured to infer metrics of an elaborated circuit design; and
a reinforcement learning (RL) engine configured to determine a correlation between the inferred metrics of the elaborated circuit design and permuton values of the elaborated circuit design, and to revise the permuton values based on the inferred metrics and the correlation to optimize the inferred metrics with respect to optimization criterion.

2. The apparatus of claim 1, further comprising:
a circuit design engine configured to generate a revised elaborated circuit design based on the revised permuton values.

3. The apparatus of claim 2, wherein:
the circuit design generator comprises a graph conversion engine configured to encode the revised elaborated circuit design in a graph-based format; and
the ML engine comprises a graph convolutional network.

4. The apparatus of claim 2, wherein the circuit design generator comprises:
an elaboration engine configured to encode the revised elaborated circuit design in register transfer level (RTL) code; and
a graph conversion engine configured to convert the RLT code to a graph-based format.

5. The apparatus of claim 2, wherein the circuit optimization engine is further configured to:
select one or more circuit designs from amongst the elaborated circuit design, the revised elaborated circuit design, and one or more further revised elaborated circuit designs as an optimized circuit design based on the inferred metrics of the respective elaborated circuit designs and the optimization criteria.

6. The apparatus of claim 2, wherein the circuit optimization engine is further configured to:
select multiple circuit designs from amongst the elaborated circuit design, the revised elaborated circuit design, and one or more further revised elaborated circuit designs as optimized circuit designs based on the inferred metrics of the respective elaborated circuit designs and the optimization criteria; and
output the selected circuit designs in a statistical likelihood framework.

7. The apparatus of claim 1, wherein the metrics comprise one or more of:
a power consumption metric;
an area metric; and
a performance metric.

8. The apparatus of claim 1, wherein the metrics comprise one or more of:
a cell area metric;
a leakage power metric;
a switching power metric;
an internal power metric;
a total power metric;
a congestion metric;
a worst negative slack (WNS) metric; and
a total negative slack (TNS) metric.

9. A machine-implemented method, comprising:
generating an elaborated circuit design based on a high-level circuit design and permuton values for permutons of the high-level circuit design;
inferring metrics of the elaborated circuit design with a machine-learning (ML) engine;
evaluating the inferred metrics and the permuton values of the elaborated circuit design, and revising the permuton values based the evaluation to optimize the inferred metrics, using a reinforcement learning (RL) engine; and
revising the elaborated circuit design based on the revised permuton values.

10. The machine-implemented method of claim 9, further comprising:
repeating the inferring, the evaluating, and the revising with respect to the revised elaborated circuit design to generate one or more further revised elaborated circuit designs.

11. The machine-implemented method of claim 10, further comprising:
selecting one or more circuit designs from amongst the elaborated circuit design, the revised circuit design, and the one or more further revised circuit designs as an optimized circuit design based on optimization criteria.

12. The machine-implemented method of claim 9, wherein:
the generating comprises encoding the elaborated circuit design in a graph-based format; and
the ML engine comprises a graph convolutional network.

13. The machine-implemented method of claim 12, wherein the encoding comprises:
encoding the elaborated circuit design as a set of node-level vectors that encapsulate logical functions of the elaborated circuit design, and a graph-level vector that encapsulates the permutons.

14. The machine-implemented method of claim 9, wherein the generating comprises:
encoding the elaborated circuit design in register transfer level (RTL) code; and
converting the RTL code to a graph-based format.

15. The machine-implemented method of claim 9, further comprising:
training the ML engine to correlate training elaborated circuit designs generated from the high-level circuit design with training metrics computed from the training elaborated circuit designs.

16. The machine-implemented method of claim 9, further comprising:
training the ML engine to correlate training elaborated circuit designs generated from one or more other high-level circuit designs with training metrics computed from the training elaborated circuit designs.

17. The machine-implemented method of claim 9, further comprising:
training the RL engine to correlate metrics of training elaborated circuit designs with permuton values of the training elaborated circuit designs.

18. A non-transitory computer readable medium comprising stored instructions, which when executed by a processor, cause the processor to:
train a machine-learning (ML) model to infer metrics of circuit designs;
train a reinforcement learning (RL) model to correlate metrics of the circuit designs with permuton values of the circuit designs;
infer metrics of a variation of a circuit design with the trained ML model;
evaluate the inferred metrics and permuton values of the variation of the circuit design, and vary the permutons based on optimization criterion, with the trained RL engine; and
generate a further variation of the circuit design based on the revised permuton values.

19. The non-transitory computer readable medium of claim 18, wherein the stored instructions, when executed by the processor, further cause the processor to:
repeat the inferring metrics, the evaluating, and the generating with respect to the further variation of the circuit design and for one or more additional further variations of the circuit design.

20. The non-transitory computer readable medium of claim 19, wherein the stored instructions, when executed by the processor, further cause the processor to:
select one or more of the variations of the circuit design as an optimal circuit design based on the respective inferred metrics and the optimization criteria.
